(19) United States
(12) Patent Application Publication
(10) Pub. No.: US 2020/0384693 A1
(43) Pub. Date: Dec. 10, 2020

(54) POWDER BED FUSION MONITORING

(71) Applicant: Raytheon Technologies Corporation, Farmington, CT (US)

(72) Inventors: Michael Walter Bennett, Lebanon, CT (US); Eklou R. Hiheglo, Manchester, CT (US); Rebecca L. Runkle, Manchester, CT (US); Amit Surana, West Hartford, CT (US); David W. Morganson, Marlborough, CT (US)

(21) Appl. No.: 16/893,790

(22) Filed: Jun. 5, 2020

Related U.S. Application Data
(60) Provisional application No. 62/858,558, filed on Jun. 7, 2019.

(51) Int. Cl. B29C 64/393; B29C 64/153; B22F 3/105; B33Y 10/00; B33Y 50/02

(52) U.S. Cl. CPC B29C 64/393; B29C 64/153; B22F 2003/1057; B33Y 10/00; B33Y 50/02; B22F 3/1055

(57) ABSTRACT

A method of monitoring an additive manufacturing build process includes first and second phases. The first phase includes depositing a powder layer onto a powder bed. A topographical profile of the powder bed is captured with a profilometer. An image of the powder bed is captured with a camera. The image and topographical profile are combined to create a data set that is transferred to a machine learning algorithm. A set of training data is generated and includes a set of deviations from a nominal model. The second phase includes depositing a powder layer onto the powder bed. An image of the powder bed is captured and compared to the set of training data. Deviations from the nominal model of the first powder bed are determined. Any deviations that are greater than a numerical threshold are labelled and identified as a defect which includes its type and severity.

### CROSS-REFERENCE TO RELATED APPLICATION(S)

This application claims the benefit of U.S. Provisional Application No. 62/858,558, filed Jun. 7, 2019 for “POWDER BED FUSION MONITORING” by M. Bennett, E. Hiheglo, R. Runkle, A. Surana, and D. Morganson.

### BACKGROUND

The present disclosure relates to additive manufacturing. More particularly, the present disclosure relates to monitoring an additive manufacturing build process.

Powder bed fusion additive manufacturing processes offer a technique capable of manufacturing a myriad of aerospace components and assemblies. The additive manufacturing process operates through repeated application of broad powder layers and then subsequent fusion of specific areas of powder to form a three dimensional workpiece. Currently, methods are insufficient for either validating that a powder layer is acceptable or for making corrections to the powder layer if the powder layer is unacceptable. Current methods to establish acceptability windows are unable to assess the type and degree of severity of a defect in a powder layer.

### SUMMARY

A method of monitoring an additive manufacturing build process includes first and second phases. The first phase includes depositing a first layer of powder onto a first powder bed. A topographical profile of a portion of the first powder bed is captured with a profilometer. An image of the first powder bed is captured with a camera. The image and the topographical profile are combined to create a first data set. The first data set is transferred to a machine learning model. A set of training data is generated with the machine learning model based on the first data set. The second phase includes depositing a second layer of power onto a second powder bed. An image of the second powder bed is captured with the camera. The image of the second powder bed is compared to the set of training data. A set of deviations from a nominal model of the first powder bed is determined based on comparison of the image of the second powder bed to the set of training data. A deviation from the set of deviations that is greater than a numerical threshold is labelled. The deviation that is greater than the numerical threshold is identified as a defect.

A method of monitoring an additive manufacturing process includes scanning a topography of a layer of a powder bed with a profilometer that is operatively coupled to an additive manufacturing machine. Deviations from a nominal model of the layer of the powder bed are measured to determine relative height data between the scanned layer of the powder bed and the nominal model. The relative height data is outputted into a machine learning algorithm. The machine learning algorithm is trained. Images of the powder bed are captured to create a set of camera data. The powder bed is monitored by using the set of camera data. A deviation in the set of camera data is identified based on the machine learning algorithm. An acceptability of the deviation is determined.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1A is a side view of a powder bed of an additive manufacturing system.

FIG. 1B is a top view of the powder bed of the additive manufacturing system.

FIG. 2A is a simplified schematic diagram of components used in a first phase of a method of monitoring an additive manufacturing build process.

FIG. 2B is a simplified schematic diagram of components used in a second phase of a method of monitoring an additive manufacturing build process.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The proposed disclosure utilizes a high precision laser profilometer to scan the powder bed as it is being formed, and combing profilometer data with data from a camera to create a machine learning algorithm to actively monitor the build process layer-by-layer.

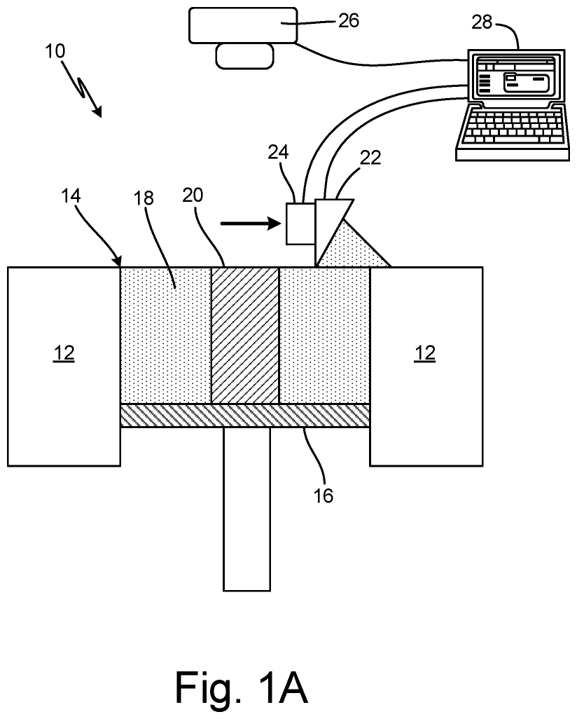

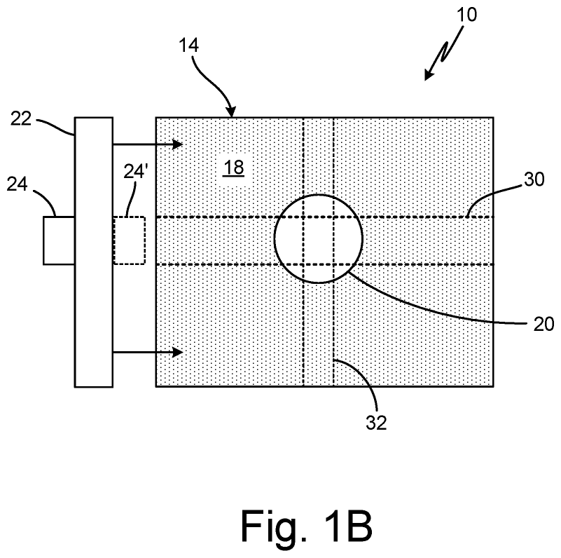

FIG. 1A is a side cross-section view of additive manufacturing system 10 and shows container walls 12, powder bed 14, build plate 16, powdered material 18, workpiece 20, recoater 22, profilometer 24, camera 26, and computer 28.

Additive manufacturing system 10 is a machine configured to produce objects with layer-by-layer additive manufacturing. In some non-limiting embodiments, additive manufacturing system 10 can be configured for laser additive manufacturing, laser powder bed fusion, electron beam powder bed fusion, laser powder deposition, electron beam wire, and/or selective laser sintering to create a three-dimensional object out of powdered material 18. Container walls 12 are containment walls that help to contain the four sides of powder bed 14. Powder bed 14 includes build plate 16, powdered material 18, and workpiece 20. Build plate 16 is a platform that is configured to move in a vertical direction (up and down as shown in FIG. 1A.). Powdered material 18 is feedstock material in powdered form. In some non-limiting embodiments, powdered material 18 can be or include titanium alloys, nickel alloys, aluminum alloys, steel alloys, cobalt-chrome alloys, copper alloys, or other types of powdered metal alloys. In other non-limiting embodiments, powdered material can include polymer powder. Workpiece 20 is an object being constructed by the layer-by-layer additive manufacturing process of additive manufacturing system 10.

Recoater 22 is a powder wiping device. In this example, recoater 22 can include a knife-blade, a roller, a brush, and a piece of rubber, used alone or in combination. Profilometer 24 is an instrument for measuring a surface profile or topography. In this non-limiting embodiment, profilometer 24 is a non-contact, laser profilometer. Camera 26 is a device for optically capturing a photographic image. Computer 28 is an electronic control device such as a desktop computer.

Container walls 12 are disposed on the sides of and are in contact with powdered material 18 of powder bed 14. Powder bed 14 is positioned below camera 26. Build plate 16 is positioned between container walls 12 and is in contact with the bottom sides of powdered material 18 and workpiece 20. Powdered material 18 is disposed on build plate 16 and between container walls 12. Workpiece 20 is disposed in and surrounded by a portion of powdered material 18 and sits upon build plate 16. Recoater 22 is positioned above build plate 16 and is configured to move relative to powdered material 18. In this example, recoater 22 is electrically connected to computer 28 via wires. In another example, recoater 22 is not electrically connected to computer 28 via wires, but instead can include a battery pack, Bluetooth communication means, and/or internal storage. In one non-limiting embodiment, recoater 22 can include and/or be attached to a powder distributing component such as a powder distribution piston.

In this example, profilometer 24 is attached to a side of recoater 22. In this non-limiting embodiment, profilometer 24 is mounted to recoater 22 such that profilometer 24 follows recoater 22 as recoater 22 moves across powder bed 14. In another non-limiting embodiment, profilometer can be mounted on the other side of recoater 22, such that profilometer leads ahead of recoater 22 as recoater 22 moves across powder bed 14. In this example, profilometer 24 is electrically connected to computer 28 via wires. In other non-limiting embodiments, profilometer 24 can be mounted onto an independent actuation system separate from recoater 22. Camera 26 is mounted above powder bed 14. In this example, camera 26 is also electrically connected to computer 28 via wires. In other non-limiting embodiments, camera 26 can include internal storage. Computer 28 is positioned away from powder bed 14 and is in data communication with recoater 22, profilometer 24, and camera 26.

Container walls 12 contain powdered material 18 within powder bed 14. Powder bed 14 is used to form workpiece 20 from powdered material 18 by way of selectively solidifying portions of powdered material 18. Build plate 16 functions as a base upon which powdered material 18 is placed and that supports workpiece 20. As workpiece 20 is formed, build plate 16 lowers after each layer of workpiece 20 is iteratively formed. Powdered material 18 serves as feedstock or raw material from which workpiece 20 is solidified and formed. After a layer powder spreading step, recoater 22 is drawn across a top surface of powder bed 14 to wipe or scrape a portion of powdered material 18 from powder bed 14. In this example, recoater 22 moves from left to right (as shown in FIG. 1A).

In this example, profilometer 24 scans across powder bed 14 during the recoating process to capture a topographical profile from the top surface of powder bed 14. Profilometer 24 emits a laser beam that is reflected off of powdered material 18 and workpiece 20. The reflected beam is then captured by a detector on profilometer 24. Based on an angle and time of return of the beam and a location on the detector, sensor software can determine how far the surface of powder bed 14 is away from profilometer 24. In this way, a high-resolution two dimensional picture of the surface of powdered bed 14 can be created. Here, given that profilometer 24 scans across powder bed 14 as profilometer 24 moves with recoater 22, profilometer 24 can capture a three-dimensional map of various surface heights of powder bed 14 as powder bed 14 is recoated with powder.

Camera 26 takes a picture of powder bed 14, both before and after additive manufacturing system 10 recoats a new layer of powder onto powder bed 14. Computer 28 controls and receives communications from the various components of additive manufacturing system 10. In this example, computer 28 also stores a machine learning algorithm that is used, in conjunction with the data from profilometer 24 and camera 26, to actively monitor the additive manufacturing build-process layer by layer.

Additive manufacturing system 10 utilizes profilometer 24 to scan powder bed 14 as powder bed 14 is being formed by the additive manufacturing layer powder spreading process. Profilometer 24 allows for capture of a very detailed and quantitative assessment of the surface of powder bed 14. Camera 26 then captures an image of powder bed 14 after the layer spreading is complete. Profilometer 24 measures deviations from a nominal model and outputs relative height data. The height data is then used for training the machine learning algorithm that is then used to monitor data from the entirety of powder bed 14 using data from camera 26. Deviations picked up by camera 26, but found to be below a numerical threshold set by profilometer 24, can be labeled as nominal in a set of training data.

In this way, the machine learning algorithm can screen out indications that are quantitatively inconsequential before reporting out defects of the layer of powder. This methodology can also be used for quantifying varying levels the impact of a defect has in the powder layer. For example, training data from camera 26 can have an additional severity level if the additional severity level is registered to profilometer 24. Profilometer 24 can also be used in tandem with camera 26 and the machine learning algorithm during an actual additive manufacturing build process to provide additional insight to the output of the machine learning algorithm. The proposed machine learning algorithm is unique and novel in that the machine learning algorithm is able to make quantitative and comparative assessments and make robust determinations on the severity of indications. Utilization of profilometer 24 enables the machine learning algorithm to be calibrated so that a user can go forward and just use data from camera 26 to monitor the build process during a production phase, instead of parsing through thousands of pictures after the build process is completed.

FIG. 1B is a top view of additive manufacturing system 10 and shows powder bed 14, powdered material 18, workpiece 20, recoater 22, profilometer 24, profilometer 24′ (shown in phantom), scan path 30 of profilometer 24, and indication 32.

Scan path 30 is a path of a scanning pattern of profilometer 24 (and/or in this example shown in FIG. 1B of profilometer 24′). Scan path 30 represents an amount of area of powder bed 14 that is scanned by profilometer 24. Indication 32 is a portion of powder bed 14 that includes some sort of deviation characteristic in powder bed 14. For example, indication 32 can signal an undesirable characteristic or defect in the condition of powdered material 18 and/or workpiece 20 in powder bed 14. In this example, a defect in powder bed 14 can include one or more of streaking in powdered material 18, hopping of recoater 22, workpiece 20 becoming exposed through the powder layer, chips or flecks from recoater 22, and incomplete spreading on the powdered lay upon powder bed 14.

Here in FIG. 1B, profilometer 24′ is shown as being mounted on an opposite side of recoater 22 from profilometer 24. In this example, profilometer 24′ is scanning powder bed 14 before recoater 22 recoats the top layer of powder on powder bed 14, with recoater 22 moving in a left-to-right direction as recoater 22 recoats powder bed 14. In another example, additive manufacturing system 10 can include both profilometers 24 and 24′ to allow for scanning powder bed 14 on both sides of recoater 22. This dual-profilometer setup can be utilized in conjunction with a recoater that is configured to recoat in both directions (e.g., left-to-right and right-to-left as shown in FIG. 1B). Here, recoater 24′ scans powder bed 14 before recoater 22 coats a new layer of powder onto powder bed 14, while recoater 24 scans powder bed 14 after recoater 22 coats a new layer of powder onto powder bed 14.

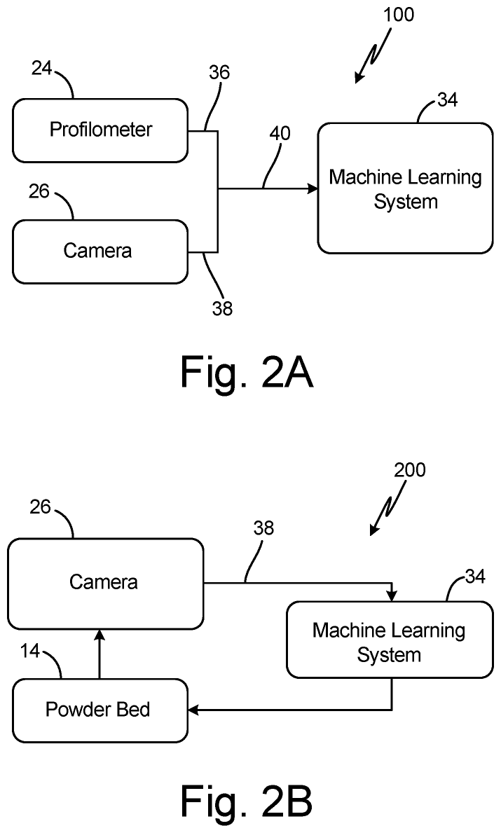

In one non-limiting embodiment, a method of monitoring an additive manufacturing build process of workpiece 20 using additive manufacturing system 10 includes two phases (e.g., the first phase illustrated in FIG. 2A and the second phase illustrated in FIG. 2B). FIG. 2A is a simplified schematic diagram of components used in the first phase of the method of monitoring the additive manufacturing build process. FIG. 2A shows system 100 with profilometer 24, camera 26, and machine learning system 34, as well as profilometer data 36, camera data 38, and first data set 40. As described herein with respect to FIGS. 2A and 2B, the term “profilometer 24” is synonymous with the term “profilometer 24 and/or profilometer′24.”

Machine learning system 34 includes an algorithm as a set of rules or executable instructions to be followed by a computer (e.g., computer 28) for problem solving applications. Profilometer data 36 is a set of data produced by profilometer 24. In this example, profilometer data 36 represents a topological profile of a portion of powder bed 14 that is scanned by profilometer 24 (i.e., scan path 30). Camera data 38 is a set of data produced by camera 26. In this example, camera data 38 represents an optical image or photograph of powder bed 14. First data set 40 is a combined set of data that includes both profilometer data 36 and camera data 38. Machine learning system 34 is stored on a computer chip or memory of a computer such as computer 28. Profilometer data 36 is communicated from profilometer 24 to computer 28 and is input into machine learning system 34. Camera data 38 is communicated from camera 26 to computer 28 and is input into machine learning system 34.

In this example, machine learning model 34 can be built by gathering sets of data, such as profilometer data 36 and camera data 38 that include various types of defects of powder bed 14. Some examples of defects can include streaking of powdered material 18, recoater hopping, exposed of workpiece 20 through recoated powder layer, recoater chips, incomplete spreading, and the like. A database of images (e.g., camera data 38) and associated topologies (e.g., profilometer data 36) that have a bunch of these powder bed defects is built. A grid is then put on the database of images and associated topologies and each aspect of the grid is labelled as a “defect” or “no defect.” Such labelling of the grid of images and associated topologies is then used to train a classification model to be used to look at new data sets and determine whether there is a defect in powder bed 14 by using an algorithm (e.g., machine learning system 34). In one non-limiting embodiment, various severity level classifications can be designated such as low, medium, and high in addition to labeling each patch by the type of defect (e.g., streaking, hopping, incomplete spreading, etc.).

First data set 40 is compared to a nominal model of powder bed 14, with the nominal model of powder bed 14 including a uniform topography profile across each layer of powder bed 14. For example, profilometer 24 measures any deviations in the layers of powder bed 14 from the nominal model, such as at the location of indication 32. Profilometer 24 then outputs relative height data between the nominal model and the topological profile of powder bed 14. The relative height data from profilometer 24 (e.g., profilometer data 36) is then combined with camera data 38 so as to classify different regions in an image of powder bed 14 to be nominal or as having a specific type of defect (e.g. streaking, debris, incomplete spreading, etc.). In this way, machine learning system 34 can be trained by incorporating measured deviations to form a classification model. In one non-limiting embodiment, machine learning system 34 is trained by being given training examples (e.g., pairs of image regions) and class labels (nominal, streaking, debris, etc.) in order to build a discriminative model (e.g. through the use of a neural network) to learn how to map particular image regions to a particular class or type of defect found in powder bed 14.

In this first phase of method of monitoring the additive manufacturing build process of workpiece 20 using additive manufacturing system 10, a layer of powder is deposited onto powder bed 14. A topographical profile of a portion of powder bed 14 is captured with profilometer 24. For example, a topography of a portion of a first layer of powder bed 14 is captured by profilometer 24 and the topographical profile comprising data points corresponding to the topography of the portion of the first layer of powder bed 14 is created. An image of powder bed 14 is captured with camera 26. The image (i.e., camera data 38) and the topographical profile (i.e., profilometer data 36) are combined to create first data set 40. First data set 40 is transferred to machine learning system 34. A set of training data is generated based on first data set 40. The set of training data includes a nominal model of powder bed 14 and a set of deviations from the nominal model of powder bed 14.

FIG. 2B is a simplified schematic diagram of components in system 200 used in the second phase of the method of monitoring the additive manufacturing build process and shows powder bed 14, camera 26, and machine learning system 34. In this second phase of the method of monitoring the additive manufacturing build process of workpiece 20, a layer of power is deposited onto a second powder bed with the additive manufacturing system 10. The second powder bed can be the same or different powder bed as powder bed 14. With respect to FIG. 2B, the term “powder bed 14” is synonymous with the term “a second powder bed or powder bed 14”.

An image of powder bed 14 is captured with camera 26. The image of powder bed 14 is compared to the set of training data. A set of deviations from a nominal model of the first powder bed is determined. Any deviations from the set of deviations that are greater than a numerical threshold are labelled and identified as a defect. Any deviations that are less than or equal to the numerical threshold are screened out of the set of deviations. Additionally, a severity of any identified defects can be determined and assigned to the particular defect. For example, the criteria for classifying defects and therefore setting numerical threshold values can be based on the amount of deviation from nominal, the size of a singular continuous defect, and the total size of a defect compared to the area evaluated. If the defect type and size are relevant enough to impact the quality of workpiece 20, additive manufacturing system 10 can take necessary action(s) such as correcting the powder layer via recoating or by aborting the build process outright. In another example, corrective action can be taken to modify the laser parameters to accommodate the powder bed defect.

In another non-limiting embodiment, a method of monitoring an additive manufacturing process includes scanning a topography of a layer of powder bed 14 with profilometer 24 that is operatively coupled to additive manufacturing system 10. Deviations from a nominal model of the layer of powder bed 14 are measured by comparing a measured height of the layer of powder bed 14 to a height of the nominal model. The deviations are measured in order to determine relative height data between the scanned layer of powder bed 14 and the nominal model. The relative height data is output into machine learning system 34 in order to train machine learning system 34. Images of powder bed 14 are captured to create camera data 38. Powder bed 14 is monitored by using camera data 38. A deviation in camera data 38 is identified based on machine learning system 34. An acceptability of the deviation is determined by comparing a value of the deviation to a pre-set numerical threshold. If the value of the deviation is less than or equal to the pre-set numerical threshold, the deviation is screened out. If the value of the deviation is greater than the pre-set numerical threshold, the deviation is added to a data set.

A benefit of additive manufacturing system 10 with profilometer 24 and machine learning system 34 is that quantitative assessments about the condition of the entirety of powder bed 14 are enabled, resulting in enhanced decision making when it comes to deciding if powder bed 14 is acceptable or not. The ability to identify a specific size of a detected presence of an off-nominal area of powder bed 14 is critical because, for example, 10 micron indications may not be important while 10 mm indications typically are important. What's more, existing methods do not classify a type of powder bed anomaly, the classification of which could help drive different corrective actions. For instance, hopping of recoater 22 may indicate the onset of a more severe problem, while super-elevation (e.g., when a workpiece warps or curls upwards) often indicates a serious build issue and potentially an impending build failure. Some anomalies such as part failure or debris may indicate flaws in the final part, while others, such as recoater streaking or incomplete spreading can suggest damage to the additive manufacturing machine itself.

Here, the quantitative data provided by additive manufacturing system 10 promotes a more efficient use of corrective measures when indications are detected. Additionally, when machine learning system 34 determines that the size of a defect will result in poor part quality and cannot be fixed via post-build processing, then additive manufacturing system 10 can cancel the build process prematurely thereby saving time and money that would otherwise be spent repairing/finishing workpiece 20 and potentially scrapping workpiece 20 later during final inspection.

### Discussion of Possible Embodiments

A method of monitoring an additive manufacturing build process includes first and second phases. The first phase includes depositing a first layer of powder onto a first powder bed. A topographical profile of a portion of the first powder bed is captured with a profilometer. An image of the first powder bed is captured with a camera. The image and the topographical profile are combined to create a first data set. The first data set is transferred to a machine learning model. A set of training data is generated with the machine learning model based on the first data set. The second phase includes depositing a second layer of power onto a second powder bed. An image of the second powder bed is captured with the camera. The image of the second powder bed is compared to the set of training data. A set of deviations from a nominal model of the first powder bed is determined based on comparison of the image of the second powder bed to the set of training data. A deviation from the set of deviations that is greater than a numerical threshold is labelled. The deviation that is greater than the numerical threshold is identified as a defect.

The method of the preceding paragraph can optionally include, additionally and/or alternatively, any one or more of the following steps, features, configurations and/or additional components.

Capturing the topographical profile of the portion of the powder bed with the profilometer can comprise: scanning, with the profilometer, a topography of a portion of the first layer of the powder bed; and creating a topographical profile of the portion of the first layer, the topographical profile can comprise data points corresponding to the topography of the portion of the first layer of the powder bed.

The training data can comprise: a nominal model of the powder bed; and/or a set of deviations from the nominal model of the powder bed.

Any deviations that are less than or equal to the numerical threshold can be screened out of the set of deviations.

Severity of the defect can be determined based on a degree of deviation from nominal and a size of the defect; and/or a severity classification can be assigned to the defect based on the determined severity of the defect.

A method of monitoring an additive manufacturing process includes scanning a topography of a layer of a powder bed with a profilometer that is operatively coupled to an additive manufacturing machine. Deviations from a nominal model of the layer of the powder bed are measured to determine relative height data between the scanned layer of the powder bed and the nominal model. The relative height data is outputted into a machine learning algorithm. The machine learning algorithm is trained. Images of the powder bed are captured to create a set of camera data. The powder bed is monitored by using the set of camera data. A deviation in the set of camera data is identified based on the machine learning algorithm. An acceptability of the deviation is determined.

The method of the preceding paragraph can optionally include, additionally and/or alternatively, any one or more of the following steps, features, configurations and/or additional components.

Deciding an acceptability of the deviation can comprise comparing a value of the deviation to a pre-set numerical threshold.

The deviation can be screened out if the value of the deviation is less than or equal to the pre-set numerical threshold or the deviation can be added to a data set if the value of the deviation is greater than the pre-set numerical threshold.

The data set can be labelled to indicate a presence of a defect and/or a severity classification can be assigned to the defect based on a degree of deviation from nominal and a size of the defect.

Measuring deviations from a nominal model of the layer of the powder bed can comprise comparing a measured height of the layer of the powder bed to a height of the nominal model.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of monitoring an additive manufacturing build process of a workpiece using an additive manufacturing system comprising a first powder bed and a recoater configured to coat the first powder bed with a layer of powder, the method comprising:
a first phase comprising:
depositing a first layer of powder onto the first powder bed of the additive manufacturing system;
capturing a topographical profile of a portion of the first powder bed with a profilometer;
capturing an image of the first powder bed with a camera;
combining the image and the topographical profile to create a first data set;
transferring the first data set to a machine learning model; and
generating, with the machine learning model, a set of training data based on the first data set; and
a second phase comprising:
depositing a second layer of power onto a second powder bed with the additive manufacturing system;
capturing an image of the second powder bed with the camera;
comparing the image of the second powder bed to the set of training data;
determining a set of deviations from a nominal model of the first powder bed based on comparison of the image of the second powder bed to the set of training data;
labelling a deviation from the set of deviations that is greater than a numerical threshold; and
identifying the deviation that is greater than the numerical threshold as a defect.

2. The method of claim 1, wherein capturing the topographical profile of the portion of the powder bed with the profilometer comprises:
scanning, with the profilometer, a topography of a portion of the first layer of the powder bed; and
creating a topographical profile of the portion of the first layer, the topographical profile comprising data points corresponding to the topography of the portion of the first layer of the powder bed.

3. The method of claim 1, wherein the training data comprises:
a nominal model of the powder bed; and
a set of deviations from the nominal model of the powder bed.

4. The method of claim 1, further comprising:
screening any deviations that are less than or equal to the numerical threshold out of the set of deviations.

5. The method of claim, further comprising:
determining a severity of the defect based on a degree of deviation from nominal and a size of the defect; and
assigning a severity classification to the defect based on the determined severity of the defect.

6. A method of monitoring an additive manufacturing process, the method comprising:
scanning a topography of a layer of a powder bed with a profilometer that is operatively coupled to an additive manufacturing machine;
measuring deviations from a nominal model of the layer of the powder bed to determine relative height data between the scanned layer of the powder bed and the nominal model;
outputting the relative height data into a machine learning algorithm;
training the machine learning algorithm;
capturing images of the powder bed to create a set of camera data;
monitoring the powder bed by using the set of camera data;
identifying a deviation in the set of camera data based on the machine learning algorithm; and
determining an acceptability of the deviation.

7. The method of claim 6, wherein deciding an acceptability of the deviation comprises comparing a value of the deviation to a pre-set numerical threshold.

8. The method of claim 7, further comprising:
screening out the deviation if the value of the deviation is less than or equal to the pre-set numerical threshold; or
adding the deviation to a data set if the value of the deviation is greater than the pre-set numerical threshold.

9. The method of claim 8, further comprising:
labelling the data set to indicate a presence of a defect; and
assigning a severity classification to the defect based on a degree of deviation from nominal and a size of the defect.

10. The method of claim 6, wherein measuring deviations from a nominal model of the layer of the powder bed comprises comparing a measured height of the layer of the powder bed to a height of the nominal model.
